(19) United States
(12) Patent Application Publication
(10) Pub. No.: US 2016/0189573 A1
(43) Pub. Date: Jun. 30, 2016

(54) PRIVACY LABEL WITH ANTI-COUNTERFEITING FEATURE

(71) Applicant: Daniel Bush, Yonkers, NY (US)

(72) Inventor: Daniel Bush, Yonkers, NY (US)

(21) Appl. No.: 14/587,445

(22) Filed: Dec. 31, 2014

(51) Int. Cl. G09F 3/02; G09F 3/00

(52) U.S. Cl. CPC G09F 3/02; G09F 3/0288; G09F 2003/0222; G09F 2003/0226; G09F 2003/0269

(57) ABSTRACT

A label system that provides idiosyncratic labels is provided. The label system has inner labels with each at least partially circumscribed by a corresponding outer label and separable therefrom along a contoured scored line. Each contoured scored line is different such that inner labels and outer labels cannot be mismatched. In another embodiment, a printed indicator is provided across a scored line that prevents mismatching of inner labels and outer labels.

### BACKGROUND OF THE INVENTION

The subject matter disclosed herein relates to labels for packages and more particularly to labels that provide an anti-counterfeiting feature. Such a label may be particularly useful for medicinal products, including labels for prescription medications.

Many traditional labels for prescription medications both (1) data concerning the medication itself (e.g. drug name, safety warning, etc.) and (2) identifying information concerning the patient (e.g. patient's name, etc.). After the medication is depleted the patient often simply disposes of the bottle such that the bottle may subsequently be discovered by another individual. Because the label includes both medication data and identifying information for the patient, this “discovering” individual may inappropriately learn certain medical information about the patient. This potential invasion of privacy can have serious and damaging consequences. Many patients find this “vulnerability” undesirable. For example, a patient who is taking medication for treatment of a mental illness would likely wish for his or her medical condition to remain confidential.

It is all but universal in the manufacturing process that some labels print the patient's identifying information at a predetermined location on the label that is configured to be separable from the medication data. After, or even during consumption, the patient may tear the label to separate the identifying information from the medication data and thereby safeguard the patient's privacy. Unfortunately, such an ad hoc configuration is fraught with inherent risk.

Counterfeiting of medical labels is a concern for many individuals, including the patient. A nefarious individual may transpose the patient's identifying information onto medication containers that induce the patient to take the incorrect medication. Counterfeiting such labels clearly can be a security concern for the patient.

The discussion above is merely provided for general background information and is not intended to be used as wholly determinant in defining the scope of the claimed subject matter.

### BRIEF DESCRIPTION OF THE INVENTION

A label system that provides idiosyncratic labels is provided. The label system has inner labels with each at least partially circumscribed by a corresponding outer label and separable therefrom along a contoured scored line. Each contoured scored line is different such that inner labels and outer labels cannot be mismatched. In another embodiment, a printed indicator is provided across a scored line that prevents mismatching of inner labels and outer labels. Advantageously, due to the disclosed contoured perimeter, the label system is extremely difficult to counterfeit as inner labels from other label sheets, or prescription labels on bottles, cannot be successfully matched to the residual contoured perimeter left on by the outer label.

In a first embodiment, a label system is provided. The label system comprises a plurality of inner labels, each inner label at least partially circumscribed by a corresponding outer label and separable therefrom along a contoured scored line, each outer label having an identical outer perimeter, wherein each contoured scored line is different.

In a second embodiment, a label system is provided. The label system comprises a plurality of sheets comprising a plurality of inner labels such that each sheet has a corresponding inner label, each inner label at least partially circumscribed by a corresponding outer label and separable therefrom along a contoured scored line, each outer label having an identical outer perimeter, wherein each contoured scored line is different on each sheet in the plurality of sheets; each sheet comprising a backing web that supports the inner label and the outer label, the backing web comprising a first zone with a first adhesion disposed under the inner label and a second zone with a second adhesion disposed under the outer label, the first adhesion being less than the second adhesion such that the outer label is removable from the backing web without separating the inner label from the outer label.

In a third embodiment, a method for producing a label system is provided. The method comprises a step of idiosyncratically marking each sheet in a plurality of sheets with unique identifier, each sheet comprising a backing web that supports an inner label circumscribed by a corresponding outer label, the backing web comprising a first zone with a first adhesion disposed under the inner label and a second zone with a second adhesion disposed under the outer label, the first adhesion being less than the second adhesion such that the outer label is removable from the backing web without separating the inner label from the outer label, each outer label having an identical outer perimeter, wherein each unique identifier renders each inner label and each outer label in the plurality of sheets unique.

This brief description of the invention is intended only to provide an overview of subject matter disclosed herein according to one or more illustrative embodiments, and does not serve as a final guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts an exemplary label system with different first and second label sheets;

FIG. 2A, FIG. 2B and FIG. 2C show the labels system in use and a mismatched label;

FIG. 3 is a schematic depiction of one method for making a label system;

FIG. 4 is an enlarged view of bottle label;

FIG. 5 depicts the bottle label after a contoured scored line has been formed;

FIG. 6A, FIG. 6B and FIG. 6C depict respective outer labels with printed borderlines;

FIG. 7 depicts an alternative embodiment of a label system;

FIG. 8A illustrates a label system using at least one printed indicator;

FIG. 8B illustrates a label system with an alternative printed indicator;

FIG. 8C illustrates a label system with an alternative printed indicator;

FIG. 9 depicts another exemplary label system;

FIG. 10 illustrates examples of high adhesive and low adhesive zones;

FIG. 11 depicts an exemplary label system with contoured scored lines; and

FIG. 12 illustrates an embodiment with an alternative tab location.

### DETAILED DESCRIPTION OF THE INVENTION

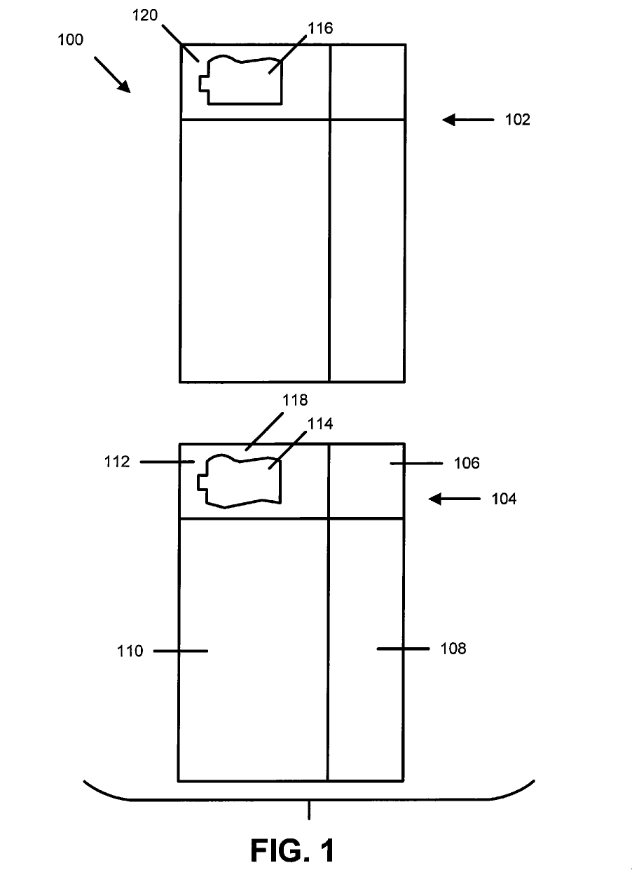

FIG. 1 depicts a label system 100 that comprises a first label sheet 102 and a second label sheet 104. Each label sheet may be, for example, a letter-sized sheet (21.6 cm by 27.9 cm) or an A4-sized sheet (21 cm by 29.7 cm), or other suitable sheet size. In the exemplary embodiment of FIG. 1, each sheet is segmented into printing zones where a pharmacy may print predetermined information. For example, the exemplary sheet 104 of FIG. 1 is segmented into a first zone 106, a second zone 108, a third zone 110 and a fourth zone 112. In the embodiment of FIG. 1, the fourth zone 112 is a bottle label zone and is separable from the other zones by scored line such that the bottle label zone may be peeled away from a backing web and adhesively attached to a medication bottle. The other zones may also be adhesive labels or may simply receive additional printed information for subsequent delivery to the patient. For example, zone 110 may have notes to the patient while zone 108 may include the receipt for the transaction.

As shown in FIG. 1, each sheet 102, 104 has a respective inner label 114, 116 each of which has a perimeter that is different. For example, the perimeter of the inner label 114 is different than the perimeter of the inner label 116. The perimeter of each inner label is defined by a contoured scored line that permits the respective inner label 114, 116 to be separable from a respective outer label 118, 120. The sheets 102, 104 may be sold to the consumer (e.g. pharmacist) in a package wherein each sheet within the package has an inner label with a distinct perimeter. In one embodiment, the perimeter is determined randomly at the time of manufacture such that an inordinate number of individually contoured perimeters are provided, each of which is essentially unique. Such individually contoured perimeters provide counterfeit protection by preventing different inner labels from being interchanged.

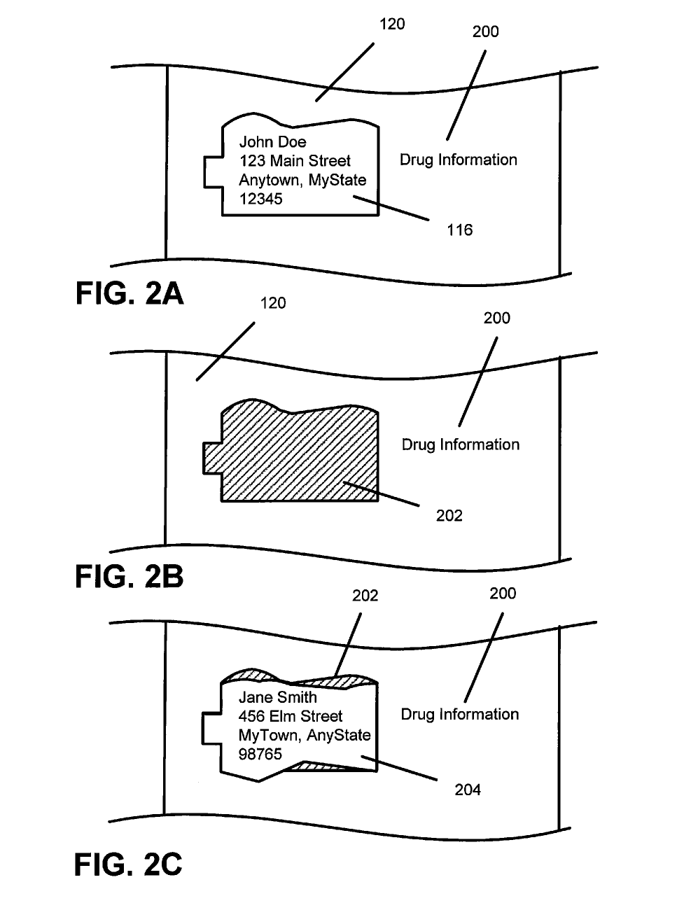

For example, and with reference to FIG. 2A and FIG. 2B, the inner label 116 is not interchangeable with other inner labels. FIG. 2A depicts the outer label 120. The outer label 120 comprises drug information 200 printed thereon. Each outer label 120 in a label package has the same shape along its outer perimeter (e.g. a rectangle of the same size and dimensions) such that the outer label 120 can be predictably attached to a bottle. When the patient has consumed the medication, or earlier should reasons of privacy dictate, the inner label 116 is removed from the outer label 120 to produce the label depicted in FIG. 2B. In FIG. 2B, the patient's identifying information has been separated from the drug information 200. In one embodiment, both the patient's identifying information and the name of the drug are removed. A different inner label cannot be placed over the opening 202 left by the removal of the inner label 116 without a discernable mismatch in the contoured perimeters. FIG. 2C depicts a failed attempt to use a mismatched inner label 204. The label system disclosed herein is simple for a pharmacy to implement because no special printer is required. A more detailed discussion follows.

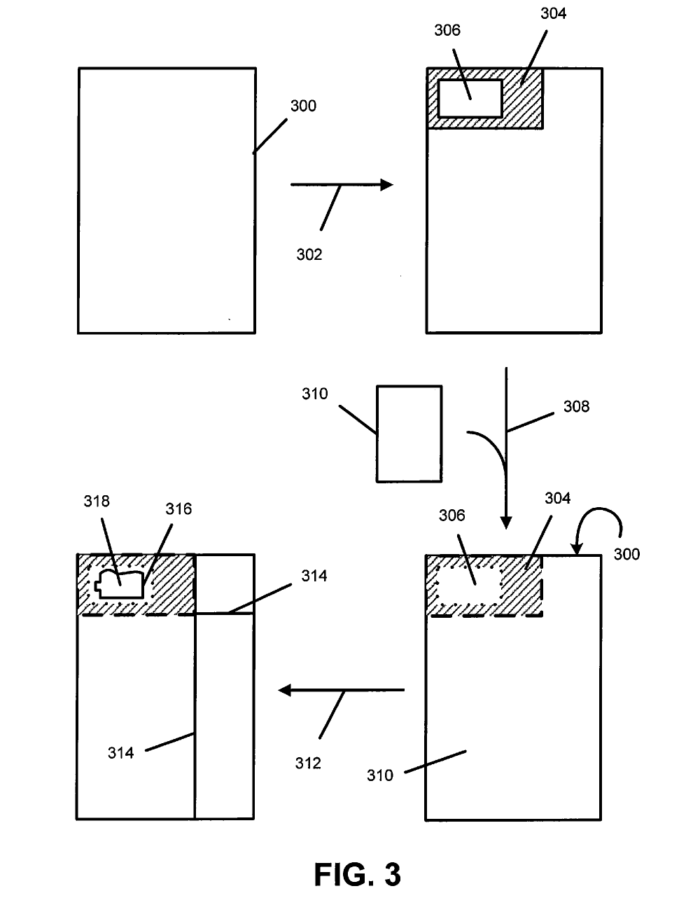

FIG. 3 is a schematic depiction of one method for making a label system. A backing web 300 is provided that functions as an underlying substrate for receiving a label web. In step 302, an adhesive is selectively deposited to define a high adhesive zone 304 that at least partially circumscribes a low adhesive zone 306. The selective application of the adhesive can be accomplished using conventional techniques, such as masking techniques. The phrases “high adhesive” and “low adhesive” refer to the relative peel force required to remove a subsequently applied label web. A higher peel force is used to remove the label web from the high adhesive zone 304 than is used to remove the label web from the low adhesive zone 306. In one embodiment, the low adhesive zone 306 is adhesive-free. In another embodiment, the high adhesive zone 304 and the low adhesive zone 306 comprise two different adhesives with the low adhesive zone 306 comprising a lower peel force adhesive, relative to the adhesive used in the high adhesive zone 304.

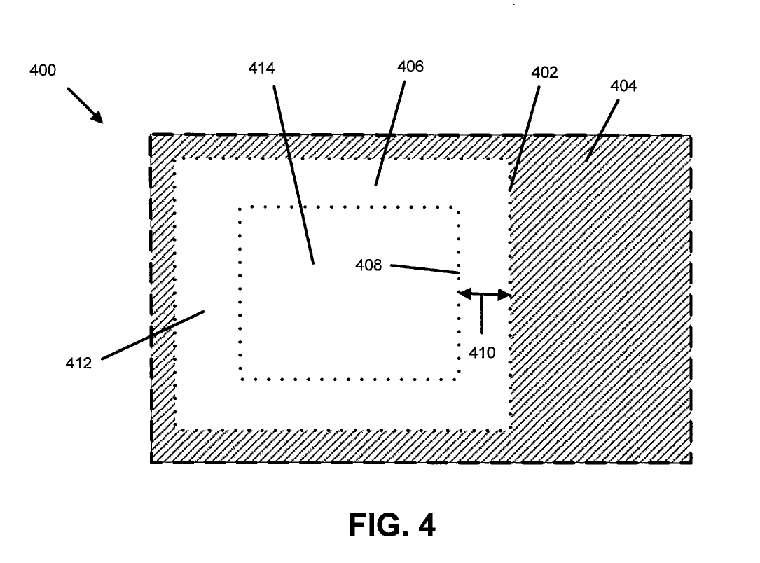

In step 308 the label web 310 is placed atop and contiguous with the backing web 300 such that the two webs are stacked. Because the high adhesive zone 304 and the low adhesive zone 306 are beneath the label web 310, these zones are shown in dotted line form. In step 312, one or more scored lines 314 are formed in the label web 310 to define various zones and permit subsequent removal of labels. Depending on the configuration of a particular label, each scored line may be selectively configured to penetrate both the label web 310 and the backing web 300 (rendering each zone separable) or only penetrate the label web 310 while leaving the backing web 300 intact (rendering the resulting label separable from the underlying backing web 300). An individually contoured scored line 316 of the inner label may be defined such that the resulting inner label 318 is stacked with regard to the low adhesive zone 306. The composition of the backing web 300, the label web 310 and the adhesive(s) are selected such that the adhesive will preferentially adhere to the label web 310 rather than to the backing web 300. Such a configuration ensures the adhesive will transfer with the label when the label is removed from the backing web 300 and attached to a bottle. In some embodiments, the backing web 300 may comprises a release layer to facilitate such a transfer. A more detailed illustration is provided in FIG. 4.

FIG. 4 is an enlarged view of bottle label 400 that comprises a high adhesive zone 404 and a low adhesive zone 406, each such zone being separated by an adhesive line 402 that was established when the adhesive was applied (see step 302 of FIG. 3). The area and position of the low adhesive zone 406 is therefore predetermined such that this area may be used to form a contoured scored line in a controlled fashion. For example, a computer may be programmed to define a computer tolerance line 408 inside of the low adhesive zone 406 and within a predetermined distance 410 of the adhesive line 402. A tolerance zone 412 is defined to exist between the adhesive line 402 and the computer tolerance line 408 wherein the contoured scored line may be scored anywhere within the tolerance zone 412. In one embodiment, the tolerance zone is sized such a distance of between about 5 mm and about 10 mm is present between the adhesive line 402 and the computer tolerance line 408. A printing zone 414 is defined to exist within an area circumscribed by the computer tolerance line 408 wherein the printing zone 414 may subsequently have patient identifying information printed therein. Such a configuration ensures the contoured scored line does not inadvertently overlap with printed patient identifying information while still permitting the contoured scored line to be both individualized and removable from the backing web.

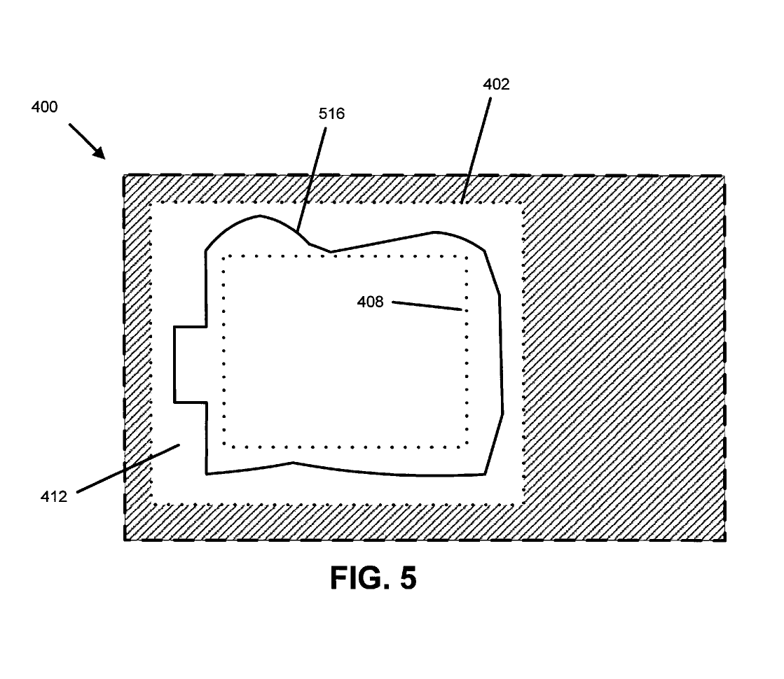

FIG. 5 depicts the bottle label 400 after a contoured scored line 516 has been formed. In the embodiment of FIG. 5, the contoured scored line 516 penetrates the label web but leaves the backing web intact such that a resulting inner label may be removed. The contoured scored line 516 may be a continuous scoring or a series of microdots. In one embodiment, the contoured scored line is a curved line that minimizes the use of sharp angles. Such curved lines reduce accidental tearing.

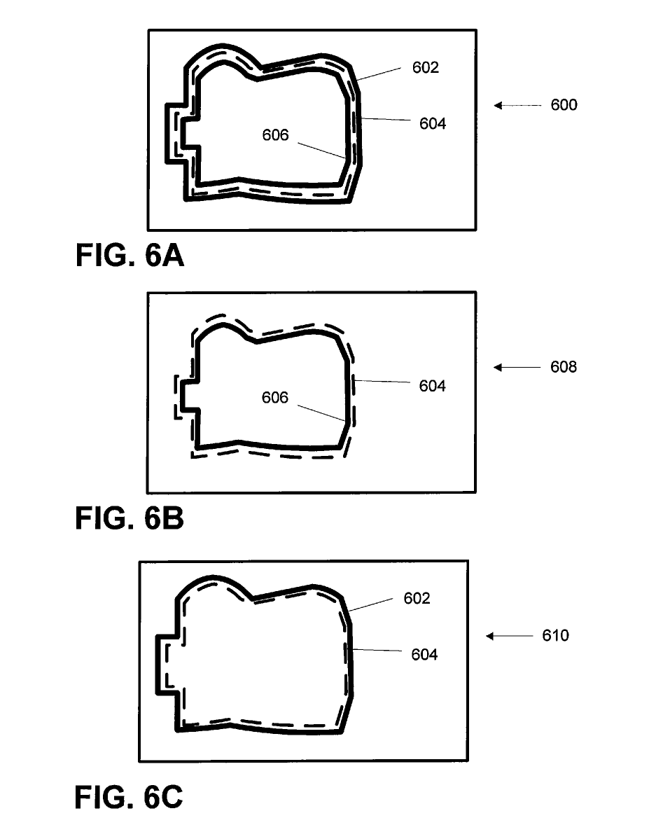

Additional information may be printed on the label sheets according to manufacturer preferences. For example, the name of a particular pharmacy may be printed on the label sheets. In one embodiment, a borderline is printed that is contiguous with the contoured scored line of the inner label. Such a borderline renders attempts to mismatch inner labels and outer labels particularly discernable. Examples of such borderlines are provided in FIG. 6A, FIG. 6B and FIG. 6C.

FIG. 6A, FIG. 6B and FIG. 6C depict respective outer labels 600, 608 and 610. For clarity of illustration, the same contoured scored line is shown in each figure and the spacing between the printed borderlines and the contoured scored line has been exaggerated. FIG. 6A depicts an outer label 600 with a contoured scored line 604. Two printed borderlines, 602 and 606 each traces the contoured scored line 604. Printed borderline 606 is disposed on the inner label while printed borderline 602 is disposed on the outer label. FIG. 6B depicts an outer label 608, wherein one printed borderline 606 is present on the inner label. The outer label is free of printed borderlines. FIG. 6C depicts an outer label 610, wherein one printed borderline 602 is present on the outer label. The inner label is free of printed borderlines.

The printed borderlines of FIG. 6A, FIG. 6B and FIG. 6C may be printed in any suitable color, including black, a shade of gray, crimson, etc. The borderline may be of a suitable thickness (e.g. 1 mm) to render it easily noticeable. In the event of a label mismatch, the mismatched color renders the mismatch even more visible. In some embodiments, the color of the printed borderline varies from one sheet to the next such that both the contoured scored line and the color of its printed borderline is individualized. In combination, these features provide an inordinate number of possible individual inner labels.

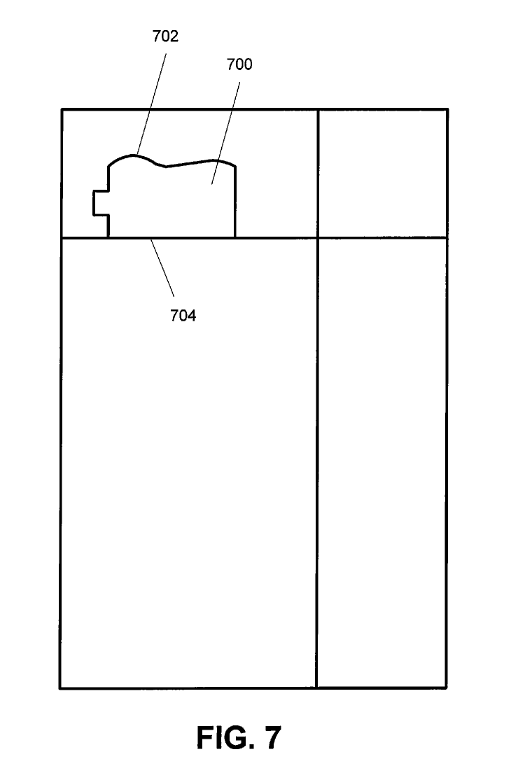

As shown in FIG. 7, the inner label need not be completely circumscribed by the outer label. FIG. 7 depicts an inner label 700 that has a contoured perimeter that is contoured along its upper edge 702. A lower edge 704 of the inner label 700 contacts a straight edge that defines the terminus of the zone. Due to the presence of at least one contoured edge in the contoured perimeter, the anti-counterfeiting features disclosed herein is still realized.

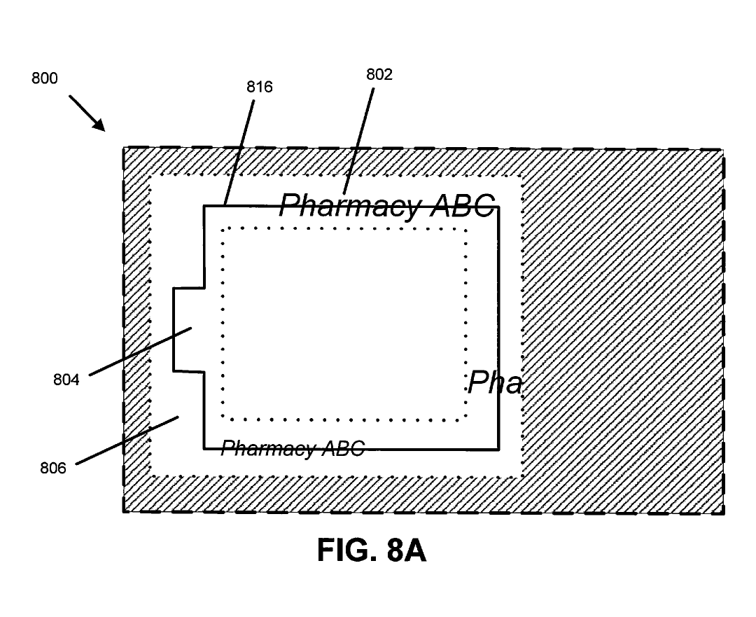

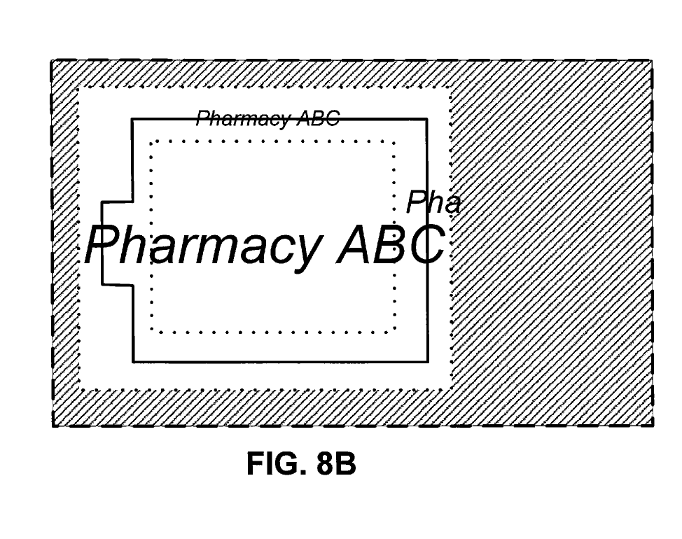

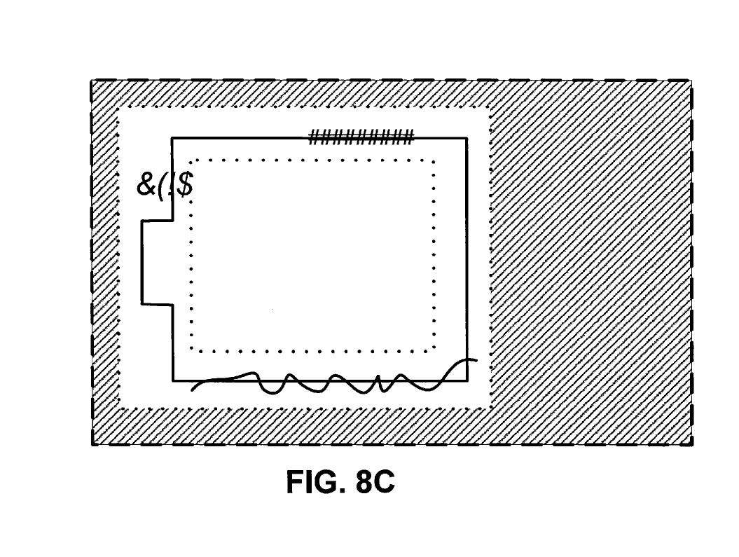

FIG. 8A depicts the bottle label 800 after a scored line 816 has been formed. In the embodiment of FIG. 8A, the scored line 816 penetrates the label web but leaves the backing web intact such that a resulting inner label may be removed. The scored line 816 may be a continuous scoring or a series of microdots. The bottle label 800 comprises at least one printed indicator 802 that is printed over the scored line 816 such that the printed indicator 802 is present on both an inner label 804 and an outer label 806. The printed indicator 802 may be, for example, a printed design, image, word, phrase, logo, trademark or the like. In one embodiment, the printed indicator 802 is the name of the pharmacy for whom the bottle label 800 is produced. Each printed indicator 802 is substantially unique for each bottle label 800. For example, the position, font, design and/or other parameter may be different from one bottle label to the next. In the exemplary embodiment of FIG. 8A, three printed indicators are shown in the bottle label 800 with different positions and font sizes. A different bottle label provides the bottle label 800 in a different position and/or a different font such that each bottle label is substantially unique. Attempts to mismatch an inner label with an outer label that is not its original partner results in an apparent misalignment of the printed indicator and thereby provides anti-counterfeiting protection. FIG. 8B and FIG. 8C illustrate alternative printed indicators. The printed indicators may be any suitable graphic including pictures, phrases, miscellaneous designs, and the like. In FIG. 8B, one of the printed indicators is printed over the entire inner label such that at least a portion of the printed indicator spans the scored line that defines the inner label.

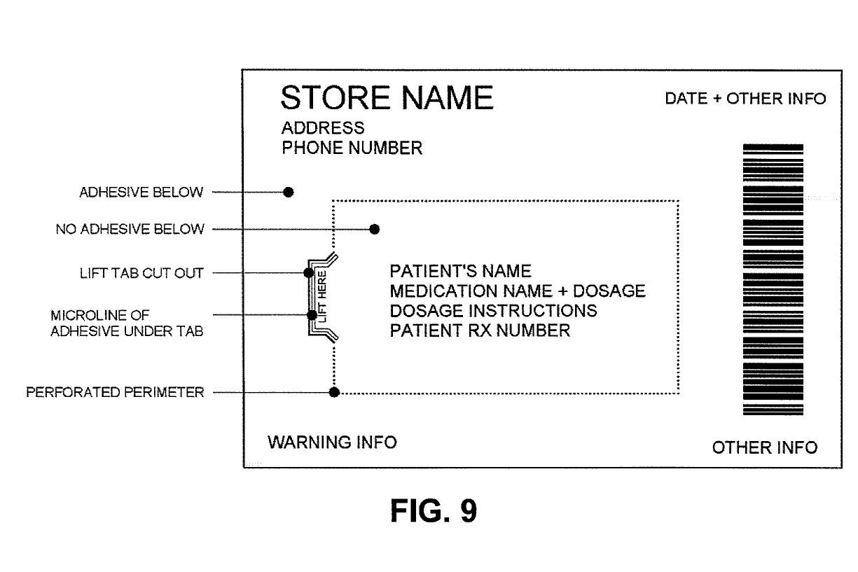

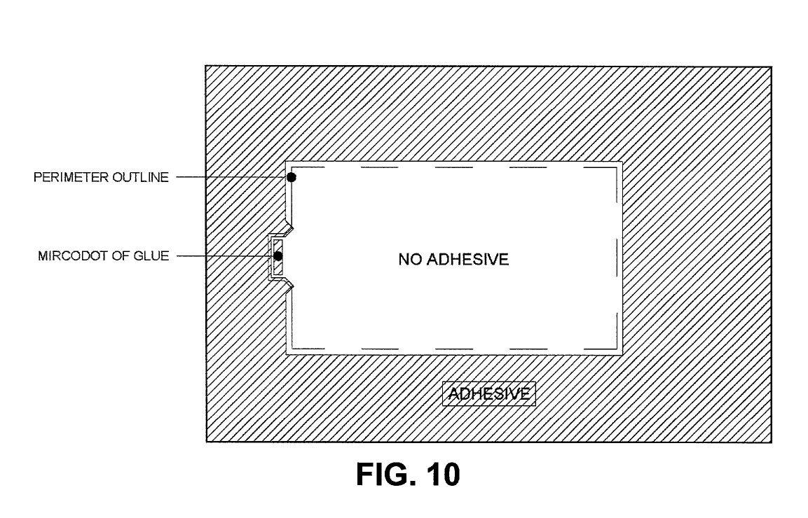

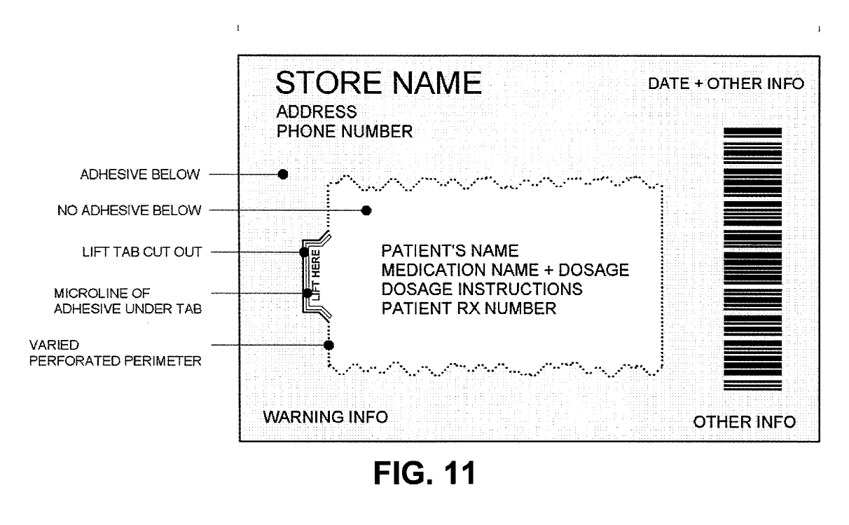

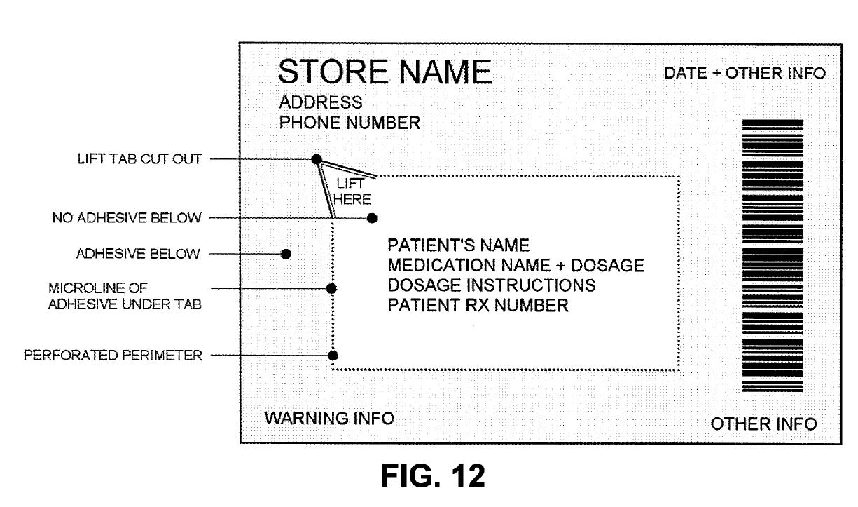

FIG. 9 depicts another exemplary label system with scored lines that are not contoured. Such a label system is useful in conjunction with a printed indicator. FIG. 10 illustrates examples of relative positioning of high adhesive and low adhesive zones. FIG. 11 depicts an exemplary label system with contoured scored lines while FIG. 12 illustrates an embodiment with an alternative tab location.

Other variations of the label system will be apparent to those skilled in the art after having benefitted from reading this disclosure. By way of illustration, the figures depict the labels being disposed on individual sheets but a plurality of individualized labels may also be formed on a single roll for use by a consumer. The labels illustrated in the figures also include a tab to promote removal of the inner label. The tab may be placed in positions other than the positions illustrated in the figures or even not provided entirely without departing from the scope of the disclosed system.

Contoured scored line may be manufactured using known techniques. For example, each contoured scored line of each label system may be idiosyncratically formed according to the teachings of U.S. Pat. No. 5,091,052. Similarly, each printed indicator may be idiosyncratically printed using conventional printing methods and randomly determines position, font, font size, design and other parameters for each label.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A label system comprising a plurality of inner labels, each inner label at least partially circumscribed by a corresponding outer label and separable therefrom along a contoured scored line, each outer label having an identical outer perimeter, wherein each contoured scored line is different.

2. The label system as recited in claim 1, further comprising a printed borderline that traces the contoured scored line.

3. The label system as recited in claim 2, wherein the printed borderline is on the inner label.

4. The label system as recited in claim 2, wherein the printed borderline is on the outer label.

5. The label system as recited in claim 1, further comprising a first printed borderline that traces the contoured scored line on the inner label and a second printed borderline that traces the contoured scored line on the outer label.

6. The label system as recited in claim 1, wherein the plurality of inner labels are provided on a roll.

7. The label system as recited in claim 1, wherein the plurality of inner labels are provided on a plurality of sheets such that each sheet comprises at least one of the inner labels and the corresponding outer label.

8. A label system comprising:
a plurality of sheets comprising a plurality of inner labels such that each sheet has a corresponding inner label, each inner label at least partially circumscribed by a corresponding outer label and separable therefrom along a contoured scored line, each outer label having an identical outer perimeter, wherein each contoured scored line is different on each sheet in the plurality of sheets;
each sheet comprising a backing web that supports the inner label and the outer label, the backing web comprising a first zone with a first adhesion disposed under the inner label and a second zone with a second adhesion disposed under the outer label, the first adhesion being less than the second adhesion such that the outer label is removable from the backing web without separating the inner label from the outer label.

9. The label system as recited in claim 8, wherein the inner label is spaced from the second zone.

10. The label system as recited in claim 8, further comprising a printed borderline that traces the contoured scored line.

11. The label system as recited in claim 10, wherein the printed borderline is on the inner label.

12. The label system as recited in claim 10, wherein the printed borderline is on the outer label.

13. The label system as recited in claim 8, further comprising a first printed borderline that traces the contoured scored line on the inner label and a second printed borderline that traces the contoured scored line on the outer label.

14. A method for producing a label system, the method comprising a step of idiosyncratically marking each sheet in a plurality of sheets with unique identifier, each sheet comprising a backing web that supports an inner label circumscribed by a corresponding outer label, the backing web comprising a first zone with a first adhesion disposed under the inner label and a second zone with a second adhesion disposed under the outer label, the first adhesion being less than the second adhesion such that the outer label is removable from the backing web without separating the inner label from the outer label, each outer label having an identical outer perimeter, wherein each unique identifier renders each inner label and each outer label in the plurality of sheets unique.

15. The method as recited in claim 14, wherein the unique identifier is a contoured scored line that circumscribes each inner label.

16. The method as recited in claim 15, wherein each sheet in the plurality of sheets has a different contoured scored line.

17. The label system as recited in claim 16, further comprising a printed borderline that traces the contoured scored line.

18. The method as recited in claim 14, wherein the unique identifier is a printed indicator that is printed partially on the inner label and partially on the outer label, wherein each sheet in the plurality of sheets has a different printed indicator.

19. The method as recited in claim 18, wherein each printed indicator is different in at least one parameters selected from the group consisting of position, size, font, font size, and combinations thereof.

20. The method as recited in claim 19, wherein the inner label is spaced from the second zone.
